(19) United States
(12) Patent Application Publication
(10) Pub. No.: US 2025/0010837 A1
(43) Pub. Date: Jan. 9, 2025

(54) MULTI-ANGLE BALL RAMP BRAKE ACTUATOR WITH AUTO-GAP ADJUSTER

(71) Applicant: Aircraft Wheel and Brake, LLC., Avon, OH (US)

(72) Inventors: Eric A. POLCUCH, Mission Viejo, CA (US); Michael J. GLOW, Farmington, UT (US)

(73) Assignee: Aircraft Wheel and Brake, LLC., Avon, OH (US)

(21) Appl. No.: 18/710,028

(22) PCT Filed: Dec. 8, 2022
(86) PCT No.: PCT/US2022/081167

§ 371 Date: May 14, 2024

Related U.S. Application Data
(60) Provisional application No. 63/288,032, filed on Dec. 10, 2021.

(51) Int. Cl. B60T 13/74; F16D 55/38; F16D 65/18; F16D 65/56; F16D 121/24; F16D 125/36; F16D 125/40; F16D 125/48

(52) U.S. Cl. CPC B60T 13/746; F16D 55/38; F16D 65/183; F16D 65/567; F16D 2121/24; F16D 2125/36; F16D 2125/40; F16D 2125/48

(57) ABSTRACT

A brake actuator is configured to perform either a braking operation, or an auto-adjustment operation of an air gap between an actuator output shaft and a brake stack. The brake actuator includes a conjugate ramp track containing a bearing ball, the conjugate ramp track being formed by matching ball ramp tracks of an input ball ramp and an output ball ramp. The output ball ramp is connected to the output shaft by a threaded interface to move the output shaft by rotation of the input ball ramp. The conjugate ramp track is a multi-angle ball ramp track thereby including areas of different gain. The input ball ramp is rotated in a first direction to perform the braking operation, and the input ball ramp is rotated in a second, opposite direction to perform the auto-adjustment operation. During the auto-adjustment operation, a position of the output shaft is automatically adjusted when the air gap has a dimension that is larger than an operable dimension to adjust the air gap to be within the operable dimension.

### FIELD OF INVENTION

The present application relates to an output stage of an electric brake actuator, such as for example for use in an aircraft braking system.

### BACKGROUND OF THE INVENTION

The current state of the art in aerospace wheel electric brake systems is to use a motor to drive a ball screw through a gear train to apply brake pressure. There are certain disadvantages of ball screw configurations. For example, there are limited suppliers of ball screws which results in associated cost and delivery issues, and limited gain may be available with ball screw configurations due to minimum lead versus load which necessitates additional gear stages being implemented into the ball screw design.

In view of such issues, an alternative electric brake system configuration employs a brake actuator having an output shaft that is driven against the brake stack. In such brake actuators, at a neutral position prior to a braking operation, an air gap is maintained between an end of the output shaft and the brake stack. The air gap initially is set to a suitable dimension for operability for efficient braking. However, as brake stack plates wear from repeated braking operations, the air gap can change, and particularly enlarge beyond the suitable operable dimension. Accordingly, the air gap needs to be adjusted periodically to ensure the air gap remains at the operable dimension for efficient braking. In conventional configurations, the air gap is set and adjusted electronically with the settings stored in memory, which has the possible risk of losing settings during certain failure modes. Conventional solutions for maintaining the air gap in an electric brake system, particularly for an aircraft brake system, have been deficient.

### SUMMARY OF INVENTION

Embodiments of the present application are used as the output stage of an electric brake actuator, and are particularly suitable for use, for example, as the output stage of an electric brake actuator for an aircraft brake system. The described actuator output stage provides the output force to energize the brake plates of the brake stack, and further includes an auto-gap adjustment mechanism to maintain an air gap in an operable dimension of the output shaft relative to the brake stack as the brake plates wear. The actuator output stage uses a ball ramp assembly that has multiple ramp angles at various degrees of rotation to tailor the output stroke and force to the desired application. The actuator output stage also includes an automatic brake air gap adjusting configuration to maintain the air gap at the operable dimension of the output shaft relative to the brake stack.

A ramp assembly with auto-gap adjustment mechanism includes an output ball ramp that is connected to an output shaft through a threaded interface. The output ball ramp has ramped ball tracks containing one or more bearing balls, with one ball per ramp track. An input ball ramp has a matching set of ramped ball tracks that interface with the bearing balls. As such, rotation of the input ball ramp relative to the output ball ramp will cause axial movement of the output ball ramp relative to the input ball ramp. The output shaft, which is threaded to the output ball ramp, will move axially in concert with the output ball ramp. The input ball ramp is driven or rotated by reduction gearing, and the input ball ramp may rotate in either direction depending on the mode of operation being a braking operation versus an auto-adjustment operation. The output ball ramp is fitted with ratchet teeth that interface with a ratchet pawl that is energized by an external or integral spring mechanism. The output ramp can only rotate in one direction due to the interaction of the ratchet and pawl to perform the auto-adjustment operation.

The opposing input and output ball ramps form a conjugate ramp track having portions of variable gain. The output ball ramp includes an output ball ramp track that guides a bearing ball, and the input ball ramp includes a matching input ball ramp track that when facing the output ball ramp form the conjugate ramp track. There may be multiple conjugate ramp tracks that are comparably configured, each receiving a respective bearing ball. The bearing balls are maintained in their respective circumferential positions with a ball cage to ensure each ramp-to-ball relationship is the same. The input and output ball ramp tracks combine to form a conjugate ramp track that has a plurality of different ramp angles for different gains depending on the stage of operation. In a neutral position, the bearing balls sit at the bottom of the conjugate ramp track.

During a braking operation, the input ball ramp is rotated in a first direction (e.g., clockwise) relative to the output ball ramp, and the bearing balls initially roll up the conjugate ramp track over a transition area. The gain of a given portion of the conjugate ramp track is defined by force output divided by torque input, and therefore the gain is relatively low between neutral position and transition area. This portion of the conjugate ramp track is intended to take up the air gap between the output shaft and the first stationary brake plate in the brake stack, and thus the output shaft rapidly closes the air gap with little rotation of the input ball ramp. The output ball ramp is held fixed from rotation by the ratchet and pawl. Continued first direction rotation of the input ball ramp relative to the output ball ramp past the transition area positions the bearing balls on a high gain portion of the conjugate ramp track, which allows for very high output force on the output ball ramp relative to input torque on the input ball ramp. This high force is applied across the brake stack assembly causing braking torque to be generated to slow the rotation of the wheel. The end of the conjugate ramp track is a functionally very steep ramp which has very low gain and effectively acts as an end of stroke stop for the braking operation.

During an auto-adjustment operation, the input ball ramp is rotated in a second direction opposite from the first direction (e.g., counterclockwise) relative to the output ball ramp, and the bearing balls roll onto an auto-adjust portion of the conjugate ramp track. The auto-adjust portion of the conjugate ramp track includes a low gain ramp that provides a displacement of the output ball ramp relative to the input ball ramp equal to the operable dimension of the air gap. Additional second direction rotation of the input ball ramp relative to the output ball ramp causes the bearing ball to come up against an adjustment stop ramp that constitutes an end of stroke stop for the auto-adjustment operation. At such point, the conjugate ramp track gain goes to nearly zero, and this action sets the air gap to the operable dimension. Additional second direction rotation of the input ball ramp drives the output ball ramp to rotate in the ratchet free direction when there is an additional air gap present beyond the operable dimension. In this manner the air gap is adjusted to the operable dimension, and the system is returned to the neutral position pending a braking command.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a drawing depicting an exemplary wheel brake system in accordance with embodiments of the present application.

FIG. 2 is a drawing depicting a schematic representation of one of the electric brake actuator components of the exemplary wheel brake system of FIG. 1.

FIG. 3 is a drawing depicting a more detailed representation of the ramp and auto-gap adjuster assembly of the electric brake actuator of FIG. 2.

FIG. 4 is a drawing depicting an isometric view of an exemplary brake actuator system in accordance with embodiments of the present application from a first viewpoint.

FIG. 5 is a drawing depicting an isometric view of the exemplary brake actuator system of FIG. 4 from a second viewpoint opposite relative to the first viewpoint.

FIG. 6 is a drawing depicting an isometric view of a portion of the exemplary electric brake actuator system, which illustrates the brake actuator being mounted within a brake housing.

FIG. 7 is a drawing depicting an isometric view of one of the brake actuators of FIG. 6 in isolation from the brake housing.

FIG. 8 is a drawing depicting an isometric view of the input ball ramp portion of the brake actuator of FIG. 7 in isolation.

FIG. 9 is a drawing depicting a close-up view of a portion of the input ball ramp of FIG. 8.

FIG. 10 is a drawing depicting an isometric view of the output ball ramp portion of the brake actuator of FIG. 7 in isolation.

FIG. 11 is a drawing depicting an isometric view of a ball cage component portion of the brake actuator in isolation.

### DETAILED DESCRIPTION

Embodiments of the present application will now be described with reference to the drawings, wherein like reference numerals are used to refer to like elements throughout. It will be understood that the figures are not necessarily to scale.

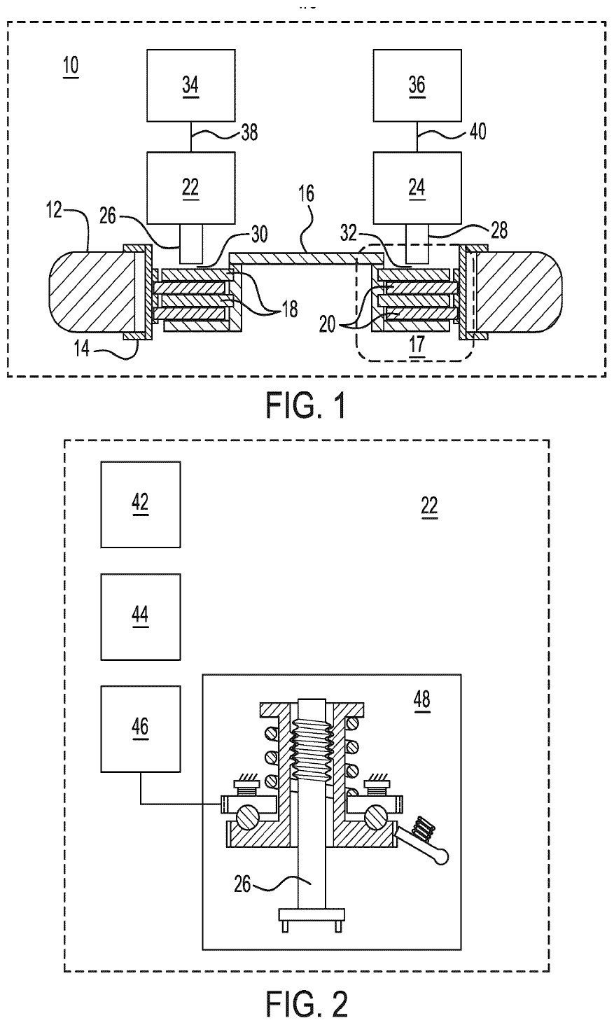

FIG. 1 is a drawing depicting an exemplary wheel brake system 10 in accordance with embodiments of the present application. FIG. 1 depicts a high-level diagram of the exemplary overall wheel brake system 10. The wheel brake system 10 includes tires 12 that are each attached to a respective rotatable wheel assembly 14 for rotation of the tire. The braking system components include a stationary torque tube 16 to which there is mounted a brake stack assembly 17 associated with each rotatable wheel assembly 14. The brake stacks each includes stationary brake plates 18 and rotating brake plates 20. Electric brake actuators 22 and 24 with respective integral output shafts 26 and 28 operate against the brake stack components to perform the braking operation to stop rotation of the rotatable wheel assemblies 14. In a neutral position prior to a braking operation, air gaps 30 and 32 are present between ends of the output shafts 26/28 and a first one of the stationary plates 18 in the brake stacks. During the braking operation, the actuators drive the output shafts to close the air gaps such that the actuators drive against the brake stacks for braking to stop rotation of the rotatable wheel assemblies. The brake actuators 22 and 24 each includes an electronic motor for driving the actuator components. The electric brake actuators 22 and 24 are controlled by electronic controllers 34 and 36 that are interconnected to the brake actuators 22 and 24 via wiring harnesses 38 and 40. The present application is focused on the brake actuators 22 and/or 24 and the associated output shafts 26 and/or 28.

FIG. 2 is a drawing depicting a schematic representation of one of the brake actuator components of the exemplary wheel brake system of FIG. 1. The electric brake actuator 22 (and the second brake actuator 24 is configured comparably) includes a parking brake assembly 42, an electric motor 44, a reduction gear set 46, and a ramp and auto-gap adjuster assembly 48. The ramp and auto-gap adjuster assembly 48 includes the output shaft 26. When the parking brake 42 is disengaged, the electric motor 44 drives operation of the ramp and auto-gap adjuster assembly 48 at a proper speed reduction as implemented via the reduction gear set 46. As referenced above, control of the electric motor 44, and thereby the ramp and auto-gap adjuster assembly 48, is performed by the electric controller 34 identified with respect to FIG. 1. The focus of this application is on the ramp and auto-gap adjuster assembly 48. Elements 42, 44, and 46 generally are well understood in existing art and may be configured in any suitable fashion. As referenced above, it will be appreciated that the electric brake actuator 24 would be configured comparably as the electric brake actuator 22.

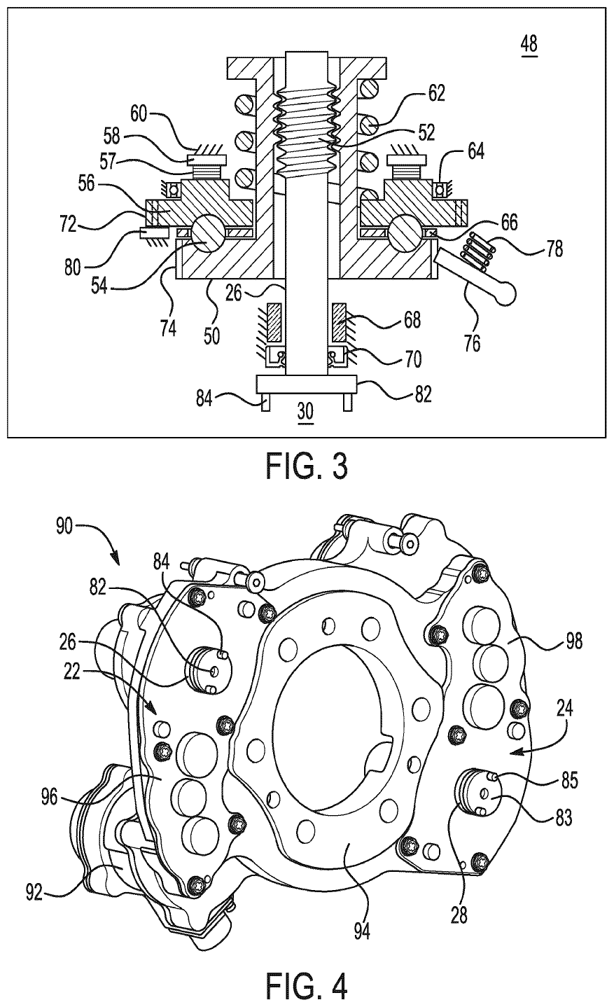

FIG. 3 is a drawing depicting a more detailed representation of the ramp and auto-gap adjuster assembly 48 of the electric brake actuator 22 of FIG. 2. The ramp and auto-gap adjuster assembly 48 includes an output ball ramp 50 which is connected to the output shaft 26 through a threaded interface 52. The output ball ramp 50 has an output ball ramp track containing a bearing ball 54. There may be more than one output ball ramp track, there being one bearing ball located in each respective output ball ramp track. An input ball ramp 56 has a matching set of input ball ramp tracks that interface with the bearing balls 54. As such, rotation of the input ball ramp 56 relative to the output ball ramp 50 will cause axial movement of the output ball ramp 50 relative to the input ball ramp 56. Details of the configuration of the ball ramp tracks are discussed in more detail below.

The output shaft 26, which as referenced above is threaded to the output ball ramp 50 via the threaded interface 52, will move axially in concert with the output ball ramp 50. Accordingly, when the input ball ramp 56 rotates, such rotation is imparted through the output ball ramp 50 to axially drive the output shaft 26 against the brake stack 17 shown in FIG. 1. The input ball ramp 56 is prevented from axial motion by a thrust bearing 57, thrust washer 58, and the brake housing 60. The input ball ramp 56 is preloaded against the output ball ramp 50 with a compression spring 62. The input ball ramp 56 is radially constrained with radial bearing 64 and the referenced brake housing 60. The bearing balls 54 are positioned circumferentially relative to each other using a ball cage 66. The output shaft 26 is radially constrained by a bushing 68 and the referenced threaded interface 52. The output shaft 26 may be sealed from the environment by a seal 70. The input ball ramp 56 is driven or rotated by the reduction gear set 46 (see schematic depiction in FIG. 2) through input gear teeth 72, and the input ball ramp 56 may rotate in either direction depending on the mode of operation being either a braking operation or an auto-adjustment operation, as further detailed below. An outer surface of the output ball ramp 50 has ratchet teeth 74 that interface with a ratchet pawl 76 that is spring loaded by a ratchet spring 78. The output ramp 50 can only rotate in one direction due to the interaction of the ratchet teeth 74 and ratchet pawl 76. The entire ramp and auto-gap adjuster assembly 48 is restrained axially within the brake housing 60 with a minimal of clearance between the thrust bearing 57 and a bumper 80.

Referring to FIG. 3 in combination with FIG. 1, in a neutral or non-braking position, there is an air gap 30 (and 32) between an end of the output shaft of the brake actuator system and a first one of the stationary brake plates 18 of the brake stack 17. In particular, the air gap 30 is present between a shaft end 82 of the output shaft 26, and the first brake plate 18 of the brake stack 17. The shaft end 82 of the output shaft 26 is fitted with anti-rotation pins 84 which interact with complementary holes in the stationary brake plate 18 of the brake stack to prevent output shaft rotation.

As referenced above, when the input ball ramp 56 rotates during a braking operation, such rotation is imparted through the output ball ramp 50 to axially drive the output shaft 26 against the brake stack 17. More specifically, the shaft end 82 is driven against the first one of the stationary brake plates 18, thereby eliminating the air gap 30 (and 32). The air gap dimension is to be minimized and adapted for a particular application, and the air gap, for example, may have an operable dimension of approximately 0.040-0.070 inches in certain aircraft applications, although any suitable air gap operable dimension may be employed depending on the particular vehicle or application. As the brake stack components wear, however, a dimension of the air gap 30 (and 32) at the non-braking neutral position changes, and particularly enlarges and can become greater than the operable dimension. Periodically, therefore, the neutral position of the output shaft 26 needs to be adjusted to reset the air gap dimension to be within the operable dimension. An aspect of the invention, therefore, is an auto-adjustment mechanism that automatically implements an air gap adjustment when the air gap becomes larger than the operable dimension.

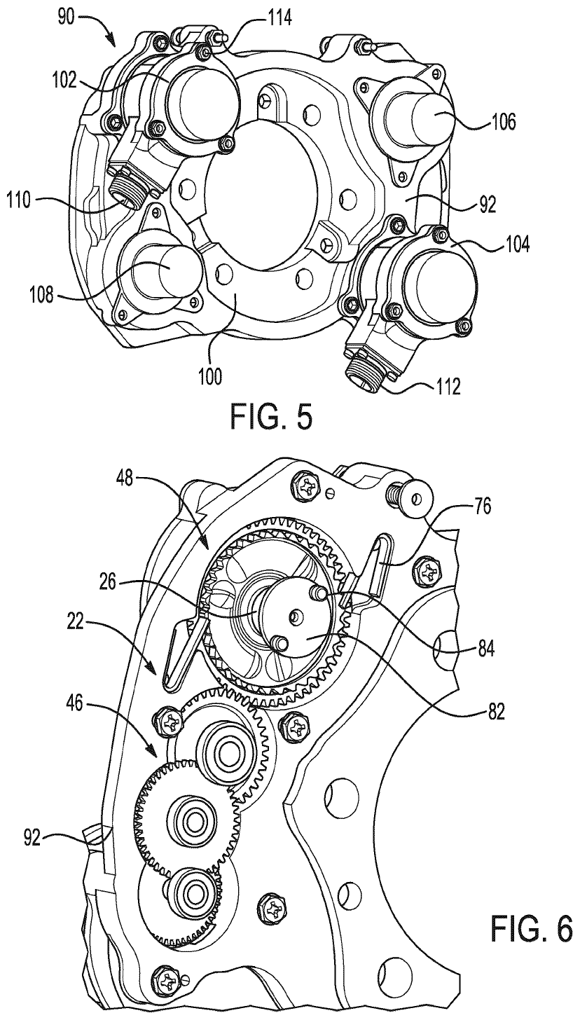

FIG. 4 is a drawing depicting an isometric view of an exemplary electric brake actuator system 90 in accordance with embodiments of the present application from a first viewpoint. FIG. 5 is a drawing depicting an isometric view of the exemplary electric brake actuator system 90 of FIG. 4 from a second viewpoint opposite relative to the first viewpoint. The brake actuator system 90 includes both the first brake actuator 22 and the second brake actuator 24 mounted or incorporated within a brake housing 92. The first viewpoint of FIG. 4 illustrates the electric brake actuator system 90 from a torque tube side, and the system includes a torque tube mounting flange 94 for mounting on the torque tube side. The system further includes brake covers 96 and 98 that are attached to the brake housing 92 to enclose the brake actuators 22 and 24 within the brake housing 92. The second viewpoint of FIG. 5 illustrates the electric brake actuator system 90 from a strut side, and the system includes a strut mounting flange 100 for mounting on the strut side.

Referring to the torque tube side viewpoint of FIG. 4, the output shaft 26 of the first brake actuator 22 extends through the first brake cover 96. In this manner, the shaft end 82 of the first output shaft 26 with anti-rotation pins 84 is positioned to interact with a first brake stack for braking. Similarly, the output shaft 28 of the second brake actuator 24 extends through the second brake cover 98. In this manner, a shaft end 83 of the second output shaft 28 with anti-rotation pins 85 is positioned to interact with a second brake stack for braking.

Referring to the strut side viewpoint of FIG. 5, the brake housing 92 further includes housing components 102 and 104 that enclose the parking brake components 42 and electric motor 44 (see FIG. 2). The brake housing 92 further includes output shaft covers 106 and 108 that cover respective ends of the output shafts opposite from the torque tube side ends. The system 90 further may include connectors 110 and 112 for providing power to the electric motors, and the system further may include multiple brake pad wear indicators 114.

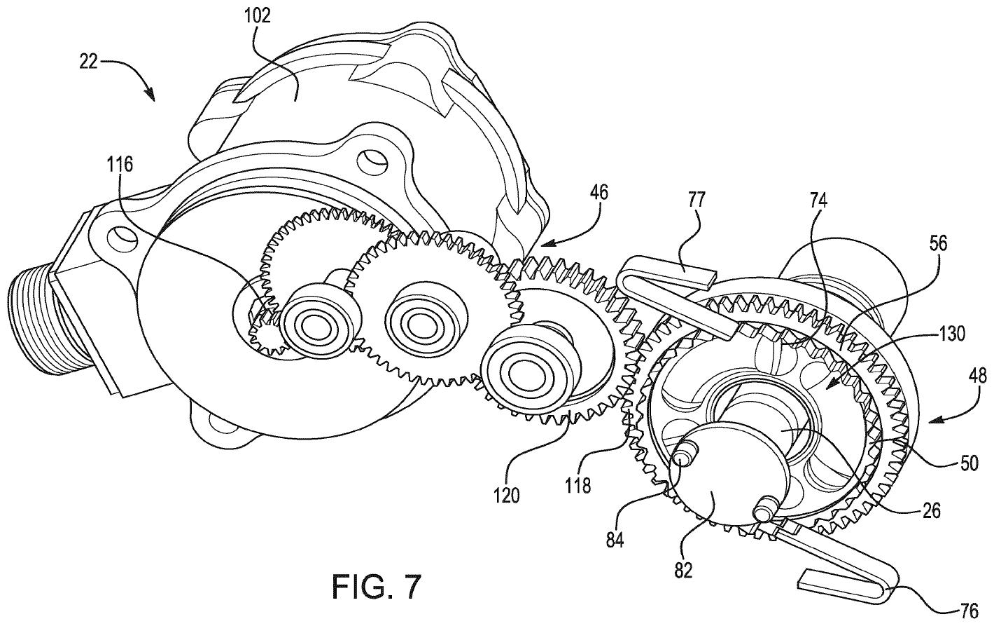

FIG. 6 is a drawing depicting an isometric view of a portion of the exemplary electric brake actuator system 90, which illustrates the first brake actuator 22 being mounted within the brake housing 92. The brake cover 96 is omitted for better illustration. FIG. 7 is a drawing depicting an isometric view the first brake actuator 22 in isolation from the brake housing and brake cover. Like reference numerals are used in FIGS. 6 and 7 as in previous figures. As referenced above, housing component 102 encloses the parking brake components 42 and electric motor 44 (see FIG. 2). FIGS. 6 and 7 further illustrate the reduction gear set 46 that was identified in block diagram form in FIG. 2. In exemplary embodiments, the reduction gear set 46 is configured as a three-stage speed reduction gear set that runs between a motor output shaft 116 and the input ball ramp 56, although any suitable speed reduction gear set may be employed.

Referring principally to the isolated view of FIG. 7, and in combination with FIGS. 2 and 3 described above, the brake actuator 22 includes the ramp and auto-gap adjuster assembly 48. The ramp and auto-gap adjuster assembly 48 includes the input ball ramp 56. The input ball ramp 56 includes an outer surface having input gear teeth 118 that mesh with opposing gear teeth 120 of the output stage of the reduction gear set 46. The ramp and auto-gap adjuster assembly 48 further includes the output ball ramp 50, which is threadedly connected to the output shaft 26 as described above in connection with FIG. 3 such that when the input ball ramp rotates, such rotation is imparted through the output ball ramp 50 to axially drive the output shaft 26 against the brake stack. An outer surface of the output ball ramp 50 includes the ratchet teeth 74 that interact with the ratchet pawl 76, and in this particular example two ratchet pawls 76 and 77 are employed to interface with the ratchet teeth 74. As further detailed below, the ratcheting of the ratchet teeth 74 relative to the ratchet pawls 76 and 77 adjusts the air gap 30 between the output shaft and the brake stack, and constitute part of the auto-adjust system to maintain an air gap in the operable dimension in response to wear of the brake components. As referenced above, it will be appreciated that the electric brake actuator 24 would be configured comparably as the electric brake actuator 22.

The input ball ramp 56 and output ball ramp 50 cooperate to form a variable gain conjugate ramp track 130, which have portions of variable gain due to the relationship of opposing input and output ball ramps at different portions of the conjugate ramp track 130. The output ball ramp includes an output ball ramp track that guides the bearing ball, and the input ball ramp includes a matching input ball ramp track that when facing the output ball ramp track forms the conjugate ramp track 130. As referenced above, there may be more than one conjugate ramp track, there being one bearing ball located in each respective conjugate ramp track. Three conjugate ramps tracks are present in the depicted example, although any suitable number may be employed. The bearing balls are maintained in their respective circumferential position with a ball cage to ensure each ramp-to-ball relationship is the same. The input and output ball ramp tracks thereby combine to form the conjugate ramp track that has a plurality of different ramps angles. In a neutral position, the bearing balls sit at the bottom of the conjugate ramp track. The conjugate ramp track also has an auto-gap adjust portion of the ball ramp track, which is a low gain ramp that provides a displacement of the output ball ramp relative to the input ball ramp to position the output shaft at an operable air gap dimension relative to the brake stack.

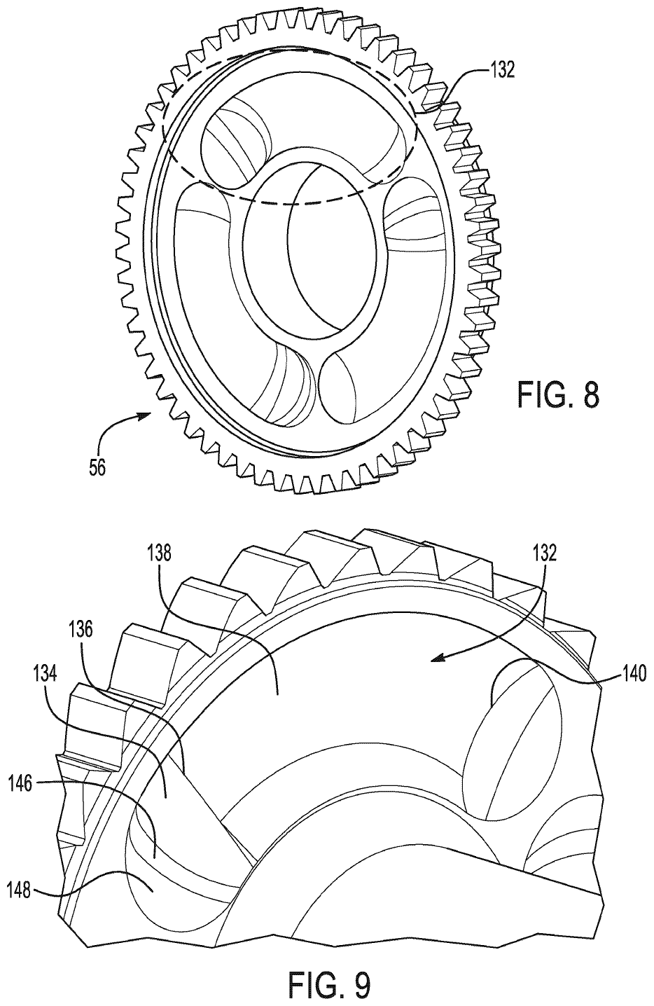

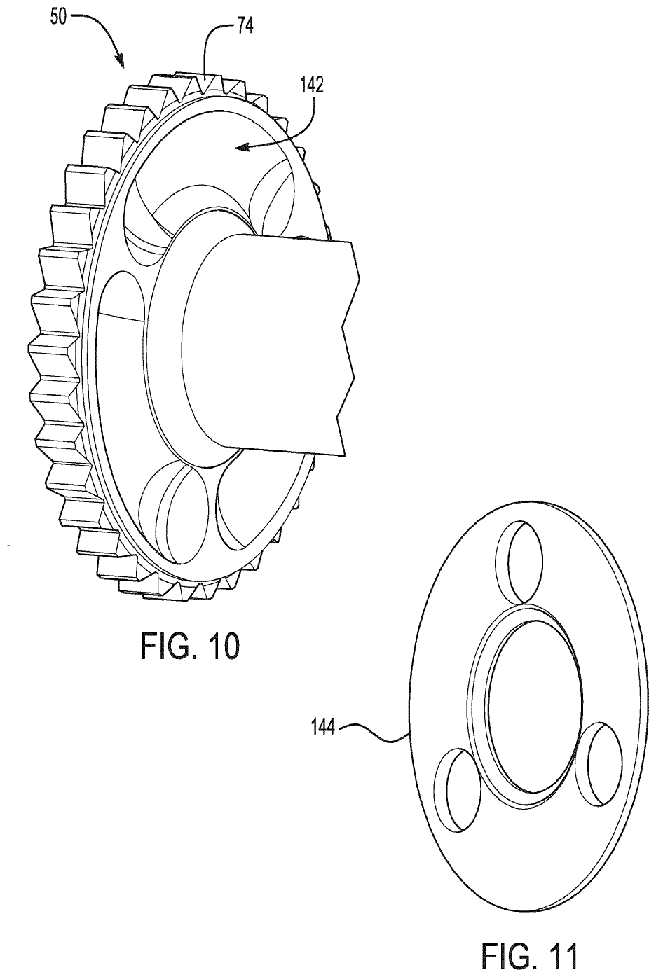

FIG. 8 is a drawing depicting an isometric view of the input ball ramp 56 portion of the brake actuator in isolation, and FIG. 9 is a drawing depicting a close-up view of a portion of the input ball ramp 56 of FIG. 8. The input ball ramp 56 includes one or more input ball ramp tracks 132 that guide the bearing balls 54 shown in FIG. 3. The input ball ramp track 132 is multi-angle ball ramp track that includes a neutral position 134, a transition area 136, and a high gain area 138 through which a bearing ball moves in a first direction during braking. Movement in the first direction is limited by a stop ramp 140. FIG. 10 is drawing depicting an isometric view of the output ball ramp 50 portion of the brake actuator in isolation. The output ball ramp 50 includes a matching set of output ball ramp tracks 142 that when facing the input ball ramp 56 form the conjugate ramp tracks. Accordingly, the output ball ramp track 142 has a matching or complementary neutral position, transition area, high-gain area, and stop ramp. The bearing balls are maintained in their respective circumferential position with a ball cage 144 positioned between the input ball ramp 56 and the output ball ramp 50 (the ball cage 144 is illustrated in isolation in FIG. 11), to ensure each ramp-to-ball relationship is the same. The input and output ball ramp tracks 132 and 142 each combine to form the conjugate ramp track that has the plurality of different ramps angles. In this example, there are three conjugate ramps tracks that respectively receive three bearing balls, although any suitable number of conjugate ramp tracks and bearing balls may be employed.

Braking operation is described with respect to the conjugate ramp track illustratively starting at the neutral position 134 and oriented looking from the input ball ramp 132 towards the output ball ramp 142. The neutral position corresponds to a non-braking position. When the input ball ramp 56 is rotated in a first direction (e.g., clockwise in the depiction of the figures) relative to the output ball ramp 50, the bearing ball initially rolls up the conjugate ramp track over transition area 136. Transition area 136 may be a simple edge or may be a distinct ramp angle. The gain of a given ramp segment is defined by force output divided by torque input, and therefore the gain is relatively low between neutral position 134 and the transition area 136. This portion of the conjugate ramp track is intended to take up the air gap 30 between the brake stationary plate 18 and the output shaft 26 rapidly and with little rotation of the input ball ramp 56. As the input ball ramp rotates, the output ball ramp 50 is held fixed from rotation by the interfacing of the ratchet teeth 74 and ratchet pawl 76 identified previously. Continued first direction (e.g., clockwise) rotation of the input ball ramp 56 relative to the output ball ramp 50 past the transition area 136 positions the bearing ball on the high gain portion 138 of the conjugate ramp track, which allows for very high output force on output ball ramp 50 relative to input torque on the input ball ramp 56. As a result, the output shaft is driven against the brake stack with a high force. This high force is applied across the brake stack assembly causing braking torque to be generated to slow the rotation of the wheel. The end of the conjugate ramp track at stop ramp 140 is a functionally very steep ramp which has very low gain and effectively acts as an end of brake stroke stop.

The above description pertains to the braking operation. As referenced above, in the neutral non-braking position, there is an air gap between an end of the output shaft of the brake actuator and a first one of the stationary brake plates of the brake stack. The air gap dimension is adapted to an operable dimension for a particular vehicle type or application (again, for example an air gap of approximately 0.040-0.070 inches is an operable dimension in certain aircraft applications). As the brake components wear, however, the air gap at the non-braking neutral position changes, and particularly enlarges to a point where the air gap is larger than the operable dimension. Periodically, therefore, the neutral position of the output shaft needs to be adjusted to reset the air gap dimension to the operable dimension. Accordingly, the conjugate ramp track further is configured to provide an automatic adjustment of the air gap.

Further as to operation of the conjugate ramp track, the auto-gap adjustment feature is achieved by rotating the input ball ramp 56 in a second direction opposite from the first direction (e.g., counterclockwise). To provide for the gap adjustment, as shown in FIG. 9 the input ball ramp further includes an auto-adjust portion that includes an auto-adjustment ramp 146 and an adjustment stop ramp 148. Similarly as above, the output ball ramp 50 has a matching or complementary auto-adjustment ramp and adjustment stop ramp to form the conjugate ramp track that includes the auto-adjust portion with the auto-adjustment ramp 146 and the adjustment stop ramp 148.

When the input ball ramp 56 is rotated in the second direction (e.g., counterclockwise) relative to the output ball ramp 50, the bearing ball rolls onto the auto-adjustment ramp 146 portion of the conjugate ramp track. The auto-adjustment ramp 146 is a low gain ramp that provides a displacement of the output ball ramp 50 relative to the input ball ramp 56 up to an amount equal to the desired air gap 30 (and 32) shown in FIGS. 1 and 3. The sum of forces between the ratchet teeth 74 and the ratchet pawls 76 and/or 77 prevents the output ball ramp 50 from freewheel rotation as the air gap is taken up by the second direction rotation. If the air gap is within the operable dimension, no further rotation is permitted once the air gap is taken up because the output shaft strikes the brake stack, and the input ball ramp is then rotated back in the first direction (clockwise) whereby the bearing ball returns to the neutral position.

If, however, the air gap has enlarged such as due to wear of the brake stack components, additional second direction (e.g., counterclockwise) rotation of the input ball ramp 56 relative to the output ball ramp 50 can occur and causes the bearing ball to come up against the adjustment stop ramp 148 constituting the end of stroke, at which point the conjugate ramp track gain goes to nearly zero. This action sets the operable air gap 30/32 as the dimensions of the components are configured in accordance with the operable air gap dimension. From this state in which there is an additional amount of air gap present beyond the operable dimension, the second direction (counterclockwise) rotation of the input ball ramp 56 drives the output ball ramp 50 to rotate in the ratchet free direction. The output shaft is prevented from rotation by the anti-rotation pins such that rotation of the output ball ramp 50 relative to the output shaft 26 causes the output shaft to be driven towards the brake stack due to the interaction of the output ball ramp/output shaft threaded interface 52 (see FIG. 3). Such movement along the threaded interface adjusts the initial position of the output shaft, and therefore the air gap, for a next braking operation. Because of the low gain of the conjugate ramp track at the end of stroke portion at the adjustment stop 148, and the low gain of the threaded interface 52, the output force can be controlled to a low value while still being able to stall the electric motor. At this point, the output ball ramp 50 rotates in the ratchet free direction to advance the ratchet teeth 74 in the ratchet free direction relative to the ratchet pawls 76/77, thereby adjusting the air gap dimension to the operable air gap dimension. With the position of output shaft having been adjusted, the input ball ramp then is rotated back in the first direction (clockwise) whereby the bearing ball returns to the neutral position for braking.

Accordingly, the adjustment operation is implemented automatically initially by rotating the input ball ramp in the second direction opposite from the braking (first) direction. If the air gap has remained at an operable dimension, then the input ball ramp rotates back to return the brake actuator to the neutral position. If, however, the air gap now exceeds the operable dimension, the resultant forces advance the output shaft and ratchet mechanism to adjust the air gap back into the operable dimension, and then the input ball ramp rotates back to return the brake actuator to the neutral position. The electronic controller for the braking system may be programmed to perform the auto-adjustment operation periodically. For example, the electronic controller may be programmed to perform the auto-adjustment operation after every braking operation, and/or at aircraft (or other vehicle) startup. In this manner, an operable air gap dimension automatically is ensured for the next braking operation.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A brake actuator for actuating against a brake stack, the brake actuator comprising:
an input ball ramp that has an input ball ramp track;
an output ball ramp that has a matching output ball ramp track relative to the input ball ramp track of the input ball ramp, whereby the input ball ramp track and the output ball ramp track form a conjugate ramp track;
a bearing ball that is received within the conjugate ramp track such that rotation of the input ball ramp imparts movement to the output ball ramp, the conjugate ramp track having a plurality of different ramp angles to form areas of different gain; and
an output shaft that is connected to the output ball ramp by a threaded interface such that the output shaft moves axially in concert with the movement of the output ball ramp to interface against the brake stack during a braking operation;
wherein the input ball ramp is rotated in a first direction to perform the braking operation, and the input ball ramp is rotated in a second direction opposite from the first direction to perform an auto-adjustment operation based on an air gap between an end of the output shaft and the brake stack; and
during the auto-adjustment operation, a position of the output shaft is adjusted when the air gap has a dimension that is larger than an operable dimension, whereby adjustment of the position of the output shaft adjusts the dimension of the air gap to be within the operable dimension.

2. The brake actuator of claim 1, wherein the conjugate ramp track has a neutral position, a transition area adjacent to the neutral position, and a high gain portion located adjacent to the transition area on a side of the transition area opposite from the neutral position, and the high gain portion has a higher gain than a gain of the transition area when the input ball ramp is rotated in the first direction to perform the braking operation; and
wherein the conjugate ramp track has an auto-adjust portion located adjacent to the neutral position on a side of the neutral position opposite from the transition area for performing the auto-adjustment operation when the input ball ramp is rotated in the second direction.

3. The brake actuator of claim 2, wherein:
the auto-adjust portion of the conjugate ramp rack includes an auto-adjustment ramp and an adjustment stop ramp on an opposite side of the auto-adjustment ramp relative to the neutral position;
during the auto-adjustment operation, when the air gap has a dimension that is within the operable dimension, the input ball ramp is rotated back to the neutral position prior to the bearing ball reaching the adjustment stop ramp and the position of the output shaft is not adjusted; and
during the auto-adjustment operation, when the air gap has a dimension that is larger than the operable dimension, the bearing ball reaches the adjustment stop ramp and the position of the output shaft adjusts the dimension of the air gap to be within the operable dimension.

4. The brake actuator of claim 1, further comprising a ratchet pawl, wherein the output ball ramp has ratchet teeth that interface with the ratchet pawl such that the output ball ramp can rotate only in one direction corresponding to a ratchet free direction; and
wherein during the auto-adjustment operation, when the air gap has a dimension that is larger than the operable dimension, the position of the output shaft is adjusted by rotating the output ball ramp in the ratchet fee direction to advance the ratchet teeth relative to the ratchet pawl.

5. The brake actuator of claim 3, further comprising a ratchet pawl, wherein the output ball ramp has ratchet teeth that interface with the ratchet pawl such that the output ball ramp can rotate only in one direction corresponding to a ratchet free direction; and
wherein during the auto-adjustment operation, when the bearing ball reaches the adjustment stop ramp, the position of the output shaft is adjusted by rotating the output ball ramp in the ratchet free direction to advance the ratchet teeth relative to the ratchet pawl.

6. The brake actuator of claim 3, wherein the adjustment stop ramp is an end of stroke stop for the auto-adjustment operation.

7. The brake actuator of claim 1, wherein during the auto-adjustment operation when the position of the output shaft is adjusted, the position of the output shaft is adjusted by the output shaft advancing along the threaded interface with the output ball ramp.

8. The brake actuator of claim 2, wherein during the braking operation the gain of the transition area is configured to move the output shaft to eliminate the air gap between the output shaft and the brake stack at the initiation of the braking operation.

9. The brake actuator of claim 8, wherein an end of the conjugate ramp track following the high gain portion is a steep ramp with low gain that acts as an end of stroke stop.

10. The brake actuator of claim 1, wherein movement of the input ball ramp is prevented from axial movement by a thrust bearing and a thrust washer.

11. The brake actuator of claim 1, wherein the input ball ramp is preloaded against the output ball ramp with a compression spring.

12. The brake actuator of claim 1, wherein input ball ramp is radially constrained with a radial bearing.

13. The brake actuator of claim 1, wherein the output shaft is fitted with anti-rotation pins that interact with the brake stack to prevent output shaft rotation.

14. The brake actuator of claim 1 having a plurality of conjugate ramp tracks and a plurality of bearing balls, wherein each of the plurality of bearing balls is maintained within a respective one of the plurality of conjugate ramp tracks.

15. The brake actuator of claim 14, further comprising a ball cage located between the input ball ramp and the output ball ramp, wherein the ball cage maintains each of the plurality of bearing balls in respective circumferential positions within the respective conjugate ball ramps to ensure each ramp-to-ball relationship is the same.

16. An electric brake system comprising:
a brake stack having one or more rotating and stationary components;
the brake actuator according to claim 1; and
an electric motor system that drives the brake actuator;
wherein the electric motor system includes an electronic controller, and the electronic controller is configured to control the brake actuator to perform the braking operation and the auto-adjustment operation.

17. The electric brake system of claim 16, wherein the controller is configured to control the actuator to perform the auto-adjustment operation after each braking operation.

18. The electric brake system of claim 16, wherein the controller is configured to control the actuator to perform the auto-adjustment operation at start-up of a vehicle containing the electric brake system.
